(19) United States
(12) Patent Application Publication
(10) Pub. No.: US 2009/0298680 A1
(43) Pub. Date: Dec. 3, 2009

(54) ALUMINUM PRODUCT AND METHOD FOR PRODUCING SAME

(75) Inventor: CHIEN-HAO HUANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/421,714

(22) Filed: Apr. 10, 2009

(30) Foreign Application Priority Data
May 30, 2008 (CN) 200810301867.5

(51) Int. Cl. B01J 27/02; B01J 21/04; B01J 23/14; B01J 23/06; B01J 23/30; B01J 23/04; B01J 23/20; C25D 11/24

(52) U.S. Cl. 502/216; 502/355; 502/351; 502/352; 502/342; 502/323; 502/341; 502/344; 502/354; 205/201

(57) ABSTRACT

An aluminum product includes an aluminum substrate, a porous alumina film formed on the aluminum substrate, and a photo-catalyst film. The alumina film has an array of pores defined on a surface thereof. The photo-catalyst film is formed on the surface of the alumina film and inner walls of the alumina film located in the pores. An exemplary method for producing the aluminum product is also provided.

### BACKGROUND

1. Technical Field

The exemplary disclosure generally relates to aluminum products, and particularly to an aluminum product including an aluminum substrate having a photo-catalyst film thereon, and an exemplary method for producing the aluminum product.

2. Description of Related Art

Aluminum is remarkable for its ability to resist corrosion and its low density. Structural components made from aluminum and its alloys are vital to the aerospace industry and other applications such as transportation and building. The reactive nature of aluminum makes it useful as a catalyst or additive in chemical mixtures, including being used in combination with a photo-catalyst film, such as titanium dioxide (TiO₂) film to allow contaminant decomposition and sterilization capability.

However, many photo-catalyst films are directly coated on a surface of an aluminum substrate, and a surface area of the aluminum substrate is quite limited for being coated the photo-catalyst films thereon to substantially sterilize microbes and decompose contaminants.

Accordingly, there is room for improvement within the art.

What is needed, therefore, is an improved aluminum product which can overcome the limitations described.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the exemplary aluminum product. Moreover, in the drawings, like reference numerals designate corresponding parts throughout the several views.

FIG. 1 is a cross-section of an aluminum product, in accordance with an exemplary embodiment.

FIG. 2 is an isometric view of an exemplary aluminum substrate of the aluminum product shown in FIG. 1 with an alumina film thereon.

FIG. 3 is a flowchart of an exemplary method for producing the exemplary aluminum product of FIG. 1.

FIG. 4 is a schematic, plan view of an exemplary sputtering apparatus for producing the exemplary aluminum product of FIG. 1.

### DETAILED DESCRIPTION

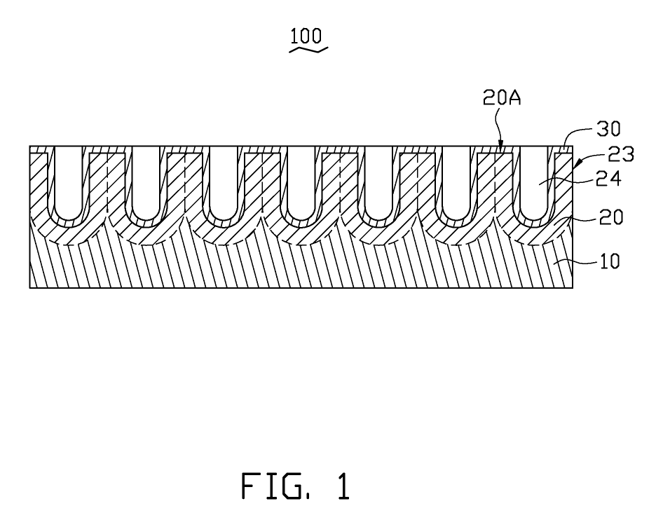

Referring to FIG. 1, an aluminum product 100, in accordance with an exemplary embodiment, includes an aluminum substrate 10, an alumina film 20, and a photo-catalyst film 30 formed on the alumina film 20.

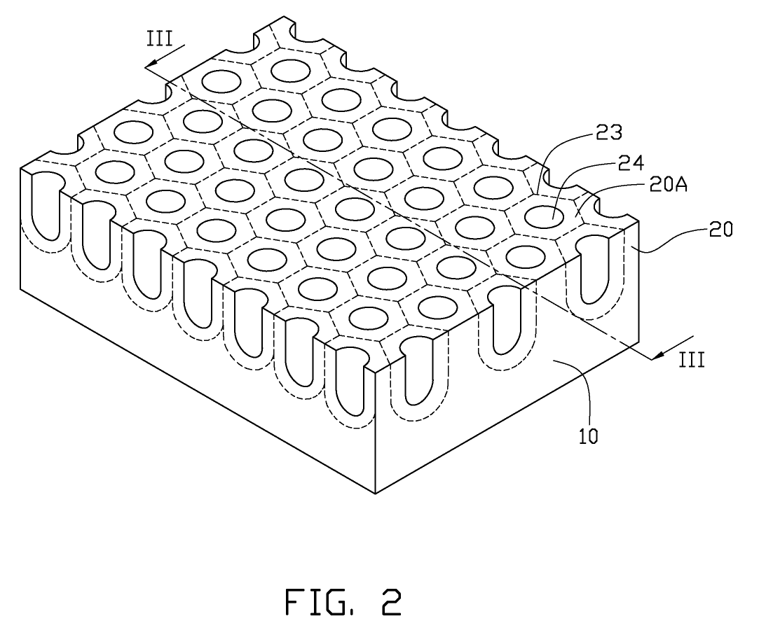

The aluminum substrate 10 can be made of pure aluminum or aluminum alloy. In the exemplary embodiment, the aluminum substrate 10 is an aluminum alloy. The alumina film 20 has a surface 20A. The photo-catalyst film 30, having a porous structure, is formed on the surface 20A, thereby exposing portions of alumina film 20 to air to decompose pollutants and allow sterilization of airborne microbes. In addition, the alumina film 20 has a porous structure. That is, the alumina film 20 is comprised by an array of cells 23 aligned uniformly, and each cell 23 has a nanometer cylindrical pore 24 defined on the surface 20A thereof, as shown in FIG. 2. The photo-catalyst layer 30 is further formed on inner walls of the alumina film 20 in the holes 24 thereof, increasing surface area of the photo-catalyst layer 30 to improve decomposition and sterilization capabilities thereof. Generally, the photo-catalyst layer 30 is made of photo-catalyst material, such as tin oxide (SnO₂), zinc oxide (ZnO), tungsten oxide (WO₃), SeTiO₃, cadmium selenide (CdSe), KTaO₃, cadmium sulfide (CdS) or niobium oxide (Nb₂O₅). Preferably, the photo-catalyst layer 30 is nanometer-sized titanium dioxide (TiO₂).

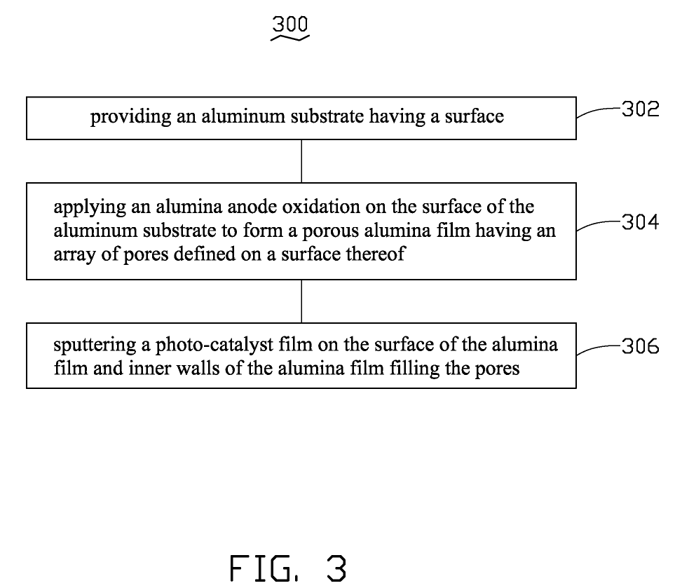

Referring to FIG. 3, an exemplary aluminum product 100 can be obtained by performing an exemplary method 300.

The method 300 may include Step 302, in which the aluminum substrate 10 is provided. The aluminum substrate 10 has a surface 12. Preferably, electrochemical polishing can be used to smoothen surface 12 of the aluminum substrate 10.

In Step 304, the alumina film 20 may be formed by applying alumina anode oxidation (AAO) on the surface 12 of the aluminum substrate 10. In operation, the aluminum substrate 10 serving as an anode, with a platinum sheet (not shown) serving as a cathode, is immersed in electrolyte solution containing acidic fluid, such as sulfuric acid, oxalic acid or phosphoric acid. The aluminum substrate 10 and the acidic fluid react to form the alumina film 20 having cylindrical pores 24. In the exemplary embodiment, reaction time for the aluminum substrate 10 and the acidic fluid is about 10 minutes to 50 minutes, with the electrolyte solution controlled at a working temperature from about 5° C. to about 25° C., and a working voltage of about 40 volts to about 60 volts is applied between the anode and the cathode. The electrolyte solution contains oxalic acid having a concentration from about 0.5 mol/L to about 1 mol/L. It can be understood that the aluminum substrate 10 can be applied by alumina anode oxidation for several times, obtaining a uniform alumina film 20 having an evenly distributed array of nanometer-sized cylindrical pores 24 defined on the surface 20A thereof. For example, a sodium hydroxide solution having a concentration 0.5 mol/L can be used to wipe off non-uniform regions of the alumina film 20 formed on the aluminum substrate 10. Then ionic water is applied to clean the aluminum substrate 10 and the alumina film 20 formed thereon, such that another alumina anode oxidation is applied until the alumina film 20 formed on the aluminum substrate 10 is uniform.

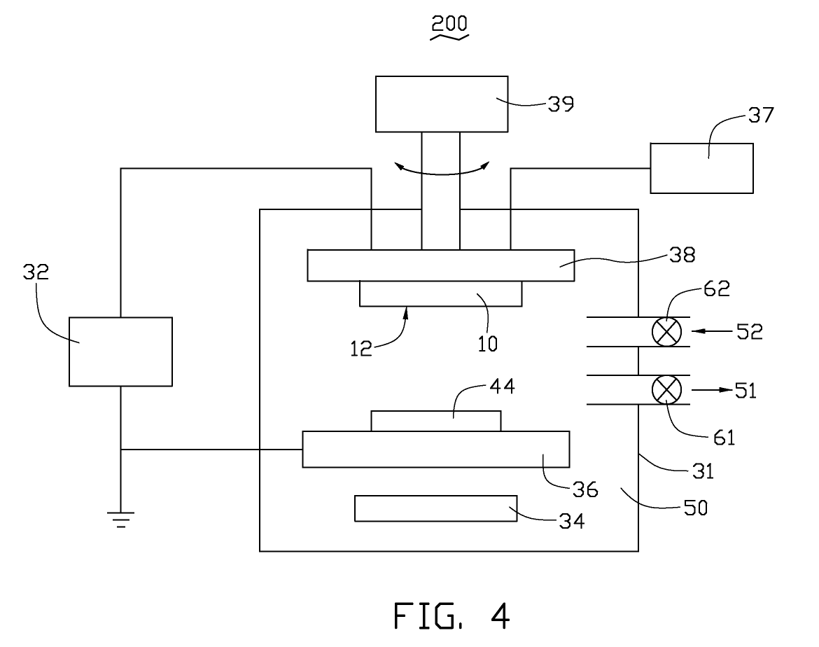

In Step 306, the photo-catalyst film 30 can be formed on the alumina film 20 by using sputtering process. In operation, the aluminum substrate 10 having the alumina film 20 formed thereon is put into a sputtering apparatus 200. As shown in FIG. 4, the sputtering apparatus 200 can be a magnetic sputtering apparatus 200, including a chamber 31, a sputtering cathode 36, a sputtering anode 38 facing the sputtering cathode 36, a heater 37 and a rotating module 39.

The chamber 31 includes a sputtering cavity 50 defined therein, a gas outlet 51 and a gas inlet 52. The gas outlet 51 and the gas inlet 52 both communicate with the sputtering cavity 50. In addition, a first valve 61 and a second valve 62 are respectively disposed at the gas outlet 51 and the gas inlet 52 for controlling the on/off states of the two valves.

In a vacuuming operation, the first valve 61 is opened while the second valve 62 is closed. A conventional vacuum pump (not shown) coupled to the gas outlet 51 draws a vacuum in the sputtering cavity 50 until the pressure in the sputtering cavity 50 reaches a predetermined vacuum degree, preferably below about 1×10⁻⁵ Torr. The gas inlet 52 is configured for introducing different kinds of gases into the chamber 31 when the first valve 61 is closed and the second valve 62 is opened. For example, atmosphere including oxygen and nitrogen, together with an inert gas, such as argon, krypton or helium can be pumped into the chamber 31 through the gas inlet 52.

During operation, the aluminum substrate 10 with the alumina film 20 formed thereon is mounted on the sputtering anode 38, and a target material 44 to be sputtered on the alumina film 20 is carried on the sputtering cathode 36. In the exemplary embodiment, the target material is titanium dioxide. The heater 37 heats up the aluminum substrate 10 and the alumina film 20 to reach a temperature from 100° C. to 250° C. When the sputtering cathode 36 and the sputtering anode 38 are electrically connected to a direct current (DC) power source 32, the gas atoms, such as the inert gas atoms are ionized. The gas ions collide with atoms of the target material 44. The atoms of the target material 44 get energy and momentum from the gas ions, thus ejecting from the target material 44, and then reaching the alumina film 20 of the aluminum substrate 10 to be deposited thereon, forming the photo-catalyst film 30. Generally, the sputtering apparatus 200 may further include a magnet 34 disposed at the center axis of the sputtering cathode 36 for facilitating ionization of gases around the target material 44, increasing the probability of collision between gas ions and the target material 44 and hence improving the speed of sputtering.

When the atoms of the target material 44 is deposited on the alumina film 20, the rotating module 40 rotates the sputtering anode 38 and the aluminum substrate 10, to ensure the photo-catalyst film 30 deposited thereon uniformly.

It is believed that the exemplary invention and its advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. An aluminum product, comprising
an aluminum substrate;
a porous alumina film formed on the aluminum substrate, the alumina film having an array of pores defined on a surface thereof;
a photo-catalyst film formed on the surface of the alumina film and inner walls of the alumina film located in the pores.

2. The aluminum product of claim 1, wherein the photo-catalyst is comprised of a material selected from the group consisting of: TiO₂, SnO₂, ZnO, WO₃, SeTiO₃, CdSe, KTaO₃, CdS and Nb₂O₅.

3. The aluminum product of claim 1, wherein the aluminum substrate is made of one of pure aluminum and aluminum alloy.

4. A method for producing an aluminum product, comprising:
providing an aluminum substrate having a surface;
applying an alumina anode oxidation on the surface of the aluminum substrate to form a porous alumina film having an array of pores defined on a surface thereof;
sputtering a photo-catalyst film on the surface of the alumina film and inner walls of the alumina film filling the pores.

5. The method of claim 4, wherein the aluminum substrate serving as an anode with a platinum sheet serving as a cathode is immersed in an electrolyte solution containing acidic fluid at a working temperature from about 5° C. to about 25° C. for about 10 minutes to about 50 minutes, with a working voltage of about 40 volts to about 60 volts applied between the anode and the cathode when applying an alumina anode oxidation on the surface of the aluminum substrate.

6. The method of claim 5, wherein the aluminum substrate and the alumina film are controlled at a temperature from about 100° C. to about 250° C. when sputtering the photo-catalyst film.

7. The method of claim 5, wherein the acidic fluid is selected from the group consisting of sulfuric acid, oxalic acid and phosphoric acid.

8. The method of claim 5, wherein the electrolyte solution contains oxalic acid having a concentration from about 0.5 mol/L to about 1 mol/L.

9. The method of claim 4, wherein the photo-catalyst film is sputtered at a pressure below about 1×10⁻⁵ Torr.

10. The method of claim 4, wherein electrochemical polishing is applied on the aluminum substrate to smoothen the surface thereof before applying an alumina anode oxidation on the surface of the aluminum substrate.
